(19) United States
(12) Patent Application Publication
(10) Pub. No.: US 2026/0298291 A1
(43) Pub. Date: Oct. 1, 2026

(54) ROLLING BEARING ARRANGEMENT

(71) Applicant: Schaeffler Technologies AG & Co. KG, Herzogenaurach (DE)

(72) Inventors: Thomas Fickert-Guenther, Hirschaid (DE); Christina Stoeber, Erlangen (DE)

(21) Appl. No.: 19/138,561

(22) PCT Filed: Nov. 17, 2023
(86) PCT No.: PCT/DE2023/100890

§ 371 Date: Jun. 12, 2025

(30) Foreign Application Priority Data
Dec. 12, 2022 (DE) 10 2022 132 961.5

(51) Int. Cl. F16C 41/00

(52) U.S. Cl. CPC F16C 41/002; F16C 19/06; F16C 19/52; F16C 2202/32

(57) ABSTRACT

The invention relates to a rolling bearing arrangement (1), comprising a rolling bearing (2) with bearing rings (3, 4) and rolling elements (5), wherein one of the bearing rings (3, 4) is designed as an inner ring (3) and another is designed as an outer ring (4), and wherein the inner ring (3) has an inner ring raceway (6) and the outer ring (4) has an outer ring raceway (7), and the rolling elements (5) are mounted so as to roll between inner ring (3) and outer ring (4), wherein a multi-part current-conducting element (8) is arranged between the inner ring (3) and the outer ring (4), which comprises a first part (9), which is designed as a disc-shaped body and is connected to the inner ring (3) or to the outer ring (4) in a current-conducting and non-rotatable manner, and a second part (10), which is connected in a current-conducting manner to the other of the bearing rings (3, 4). The second part (10) of the current-conducting element (8) is arranged so that it can rotate relative to the bearing rings (3, 4) and the first part (9) of the current-conducting element (8).

### CROSS-REFERENCE TO RELATED APPLICATION

The present application is the U.S. National Phase of PCT Patent Application Number PCT/DE2023/100890, filed on Nov. 17, 2023, which claims priority to German Patent Application Number 10 2022 132 961.5, filed Dec. 12, 2022, the entire disclosures of which are incorporated by reference herein.

### TECHNICAL FIELD

The present disclosure relates to a rolling bearing arrangement comprising a rolling bearing having an inner ring, an outer ring and rolling bodies, wherein the inner ring has an inner ring raceway and the outer ring has an outer ring raceway, and the rolling bodies are mounted in a rolling manner between the inner ring and the outer ring, and a current-conducting element is arranged between the inner ring and the outer ring and connects the inner ring to the outer ring in a current-conducting manner.

### BACKGROUND

When rolling bearings are used, e.g. in or on electrical machines or within a hybridized drive train of a motor vehicle, the passage of current may occur. The switching pulses from inverters, for example, lead to the build-up of voltage between the bearing rings of rolling bearings. This voltage is repeatedly reduced by breakdowns. Under unfavorable conditions, damage to raceways and rolling bodies from the passage of current occurs as a result. This creates the risk of premature and unexpected failure of the bearing and thus of the entire electrical machine. In addition to the increased maintenance effort, additional costs arise due to machine downtime.

Current-insulated rolling bearings are known from the prior art and are intended to prevent harmful bearing currents. For example, rolling bearings with ceramic insulation on the outer or inner ring are used. However, current-insulated rolling bearings are comparatively expensive and are therefore not used very often.

In light of the known prior art, it is therefore the object of the disclosure to provide a rolling bearing arrangement with improved protection against harmful bearing currents. It is also a particular object of the disclosure to provide a rolling bearing arrangement which provides protection against harmful bearing currents, in particular in a wet-running rolling bearing arrangement.

### SUMMARY

This object is achieved by a rolling bearing arrangement, comprising a rolling bearing having bearing rings and rolling bodies, wherein one of the bearing rings is designed as an inner ring and another as an outer ring, and the inner ring has an inner ring raceway and the outer ring has an outer ring raceway, and the rolling bodies are mounted in a rolling manner between the inner ring and the outer ring, and a multi-part current-conducting element is arranged between the inner ring and the outer ring and comprises a first part, which is designed as a disc-like body and is connected to the inner ring or to the outer ring in a current-conducting and rotationally fixed manner, and a second part, which is connected to the other of the bearing rings in a current-conducting manner, and the second part of the current-conducting element is arranged so as to be rotatably movable relative to the bearing rings and the first part of the current-conducting element.

The rolling bearing arrangement according to the disclosure can be effectively protected against unwanted bearing currents. Furthermore, the current-conducting element can be used without structural modifications to an existing rolling bearing. It is also possible to produce the current-conducting elements extremely cost-effectively using standard manufacturing processes.

Furthermore, the contact elements can preferably be individually detachable from the current-conducting element, such that the contact elements are designed to be individually replaceable as wearing parts.

The individual elements of the claimed subject matter of the disclosure are explained first in the order in which they are mentioned in the claims, after which particularly preferred embodiments of the subject matter of the disclosure are described.

Rolling bearings can be used in particular to enable rotary movements with the lowest possible frictional losses. Rolling bearings can be used in particular to affix and/or mount axles and shafts, and, depending on the design, they can absorb radial and/or axial forces and simultaneously enable the rotation of the shaft or the components mounted on an axle in this way.

For this purpose, rolling bodies are arranged so as to roll between an inner ring and an outer ring of the rolling bearing. Between these three main components—inner ring, outer ring and the rolling bodies—it is usually mainly rolling friction that occurs within the rolling bearing. Since the rolling bodies in the inner and outer ring can preferably roll on hardened steel surfaces with optimized lubrication, the rolling friction of such bearings is relatively low.

The inner ring can in particular connect the shaft accommodating the rolling bearings to the rolling bearing or the rolling bodies. In particular, the shaft can be connected to the side of the lateral surface of the inner ring facing the shaft, and the rolling bodies of the rolling bearing roll on the inner ring raceway opposite this lateral surface. The inner ring can be made of a metallic and/or ceramic material. In principle, it is conceivable to design the inner ring in one part or in multiple parts, in particular in two parts.

The outer ring can, in particular, connect the bearing system accommodating the rolling bearings to the rolling bearing or the rolling bodies. In particular, the bearing system can be connected to the side of the lateral surface of the outer ring facing the bearing system, and the rolling bodies of the rolling bearing roll on the outer ring raceway opposite this lateral surface. The outer ring can be made of a metallic and/or ceramic material. In principle, it is conceivable to design the outer ring in one part or in multiple parts, in particular in two parts.

Depending on the type of rolling bearing, the rolling bodies have the shape of a ball or a roller. They roll on the raceways of the rolling bearing and have the task of transmitting the force acting on a radial rolling bearing from the outer ring to the inner ring and vice versa. In an axial rolling bearing, the rolling bodies transmit the forces acting on the axial rolling bearing between the running discs. Roller-like rolling bodies are also referred to as roller rolling bodies and spherical rolling bodies as bearing balls.

Roller-like rolling bodies can be selected, for example, from the group of symmetrical spherical rollers, asymmetrical spherical rollers, cylindrical rollers, needle rollers and/or tapered rollers.

Rolling bodies can be guided and spaced apart in a cage or by rolling body spacers. In principle, it is also conceivable to design a rolling bearing without a cage, which is also referred to as a full-complement rolling bearing. In full-complement rolling bearings, adjacent rolling bodies can contact one another.

The rolling bodies can roll within the rolling bearing, in particular on the inner ring raceway of the inner ring. For this purpose, the surface of the inner ring raceway can advantageously be designed to be abrasion-resistant, for example by means of a corresponding surface treatment method and/or by applying a corresponding additional layer of material. The inner ring raceway can be designed to be planar or profiled. A profiled design of the inner ring raceway can be used, for example, to guide the rolling bodies on the inner ring raceway. On the other hand, a planar formation of the inner ring raceway can, for example, allow a certain axial displaceability of the rolling bodies on the inner ring raceway.

The rolling bodies can roll within the rolling bearing, in particular on the outer ring raceway of the outer ring. For this purpose, the surface of the outer ring raceway can advantageously be designed to be correspondingly abrasion-resistant, for example by means of a corresponding surface treatment method and/or by applying a corresponding additional layer of material.

The outer ring raceway can be designed to be planar or profiled. A profiled design of the outer ring raceway can be used, for example, to guide the rolling bodies on the outer ring raceway. On the other hand, a planar formation of the outer ring raceway can, for example, allow a certain axial displaceability of the rolling bodies on the outer ring raceway.

As a rule, undefined contacts between machine elements are avoided in rotating components. Therefore, guide elements known from the prior art are clamped in a fixed position or are subjected to a defined sliding movement. In contrast, the opposite is proposed within the scope of the disclosure, whereby an ideal friction-minimized current dissipation is achieved.

Preferably, the second part of the current-conducting element of the rolling bearing arrangement is not rotationally fixed but arranged in a rotationally movable manner, i.e. floatingly, in the same axial plane as the first part of the current-conducting element. Thus, the second part of the current-conducting element is only offset radially with respect to the first part. This is particularly advantageous because the required installation space is minimal and the first part of the current-conducting element can still make use of the sealing effect, at least in the sense of a labyrinth seal. With regard to the installation of the rolling bearing arrangement, this preferred design does not affect installation space.

In particular, it is preferred that the second part of the current-conducting element is designed to be loop-like. Thus, analogous to a wire ring, it is partially tangentially touching in the space between the first part of the current-conducting element and the bearing ring, which is not arranged in direct electrical contact with the first part of the current-conducting element. It should be emphasized that the second part of the current-conducting element only has the shape of a wire ring, but does not have to consist of a metallic wire.

In order to ideally guide the second part of the current-conducting element of the rolling bearing arrangement, it is proposed that a geometric contour running over the circumference is provided in the one of the bearing rings that is in direct electrical contact. This represents a particular advantage since bearing rings with a known contour, i.e. with a recess for a previously used sealing solution, can be used.

It is further conceivable that the guidance of the second part of the current-conducting element is achieved by a concave contour running over the circumference in the first part of the current-conducting element. Thus, the bearing ring not in contact with the first part of the current-conducting element only needs to have a cylindrical surface.

In order to ensure long-term constant electrical conductivity, the second part of the current-conducting element contacts the bearing ring, which is in direct electrical contact with it, and the first part of the current-conducting element under slight prestress.

In a preferred embodiment, the first part of the current-conducting element of the rolling bearing arrangement is designed as a cover disc made of steel. This represents a simple and cost-effective way of implementing the disclosure which is suitable in terms of forming. It is conceivable for this to also have a coating that improves conductivity or influences friction. The movement behavior of the second part of the current-conducting element can be influenced by a friction-influencing coating.

In a further preferred embodiment of the rolling bearing arrangement, the second part of the current-conducting element comprises carbon or carbon fibers. This has the advantage that the electrical conductivity is particularly high and good shaping is ensured.

However, it is also conceivable for the second part of the current-conducting element of the rolling bearing arrangement to be formed from a flat or round wire made of spring steel. This can be advantageous in particular operating conditions.

The disclosure is explained in more detail below with reference to figures without limiting the general concept of the disclosure.

### BRIEF DESCRIPTION OF THE DRAWINGS

In the Drawings:

FIGS. 1a and b show a first embodiment of a rolling bearing with a current-conducting element in a schematic cross-sectional view;

FIGS. 2a and b show a second embodiment of a rolling bearing with a current-conducting element in a schematic cross-sectional view;

FIGS. 3a and b show a section of the current-conducting bearing, representing two guide options for the current-conducting element.

### DESCRIPTION OF EMBODIMENTS

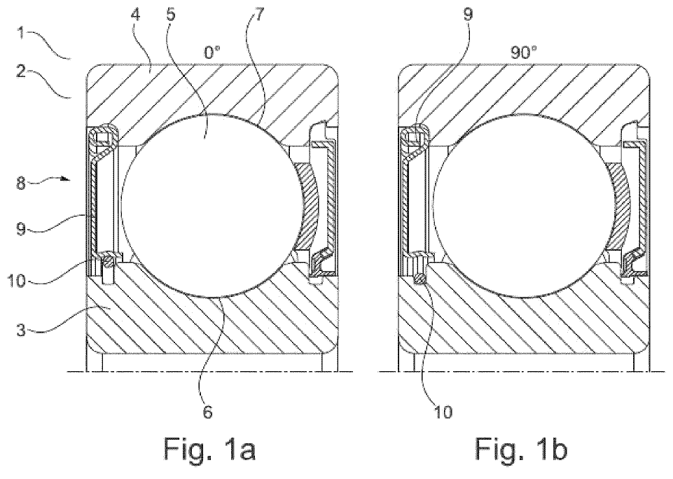

FIGS. 1a and b show a first embodiment of the rolling bearing arrangement 1, comprising a rolling bearing 2 with an inner ring 3, an outer ring 4 and rolling bodies 5. The inner ring 3 has an inner ring raceway 6 and the outer ring 4 has an outer ring raceway 7. The rolling bodies 5 are mounted in a rolling manner between the inner ring 3 and the outer ring 4, and a current-conducting element 8 is arranged between the inner ring 3 and the outer ring 4 and connects the inner ring 3 to the outer ring 4 in a current-conducting manner.

The current-conducting element 8 is multi-part, and a first part 9 is designed as a disc-like body and is connected to the outer ring 4 in a current-conducting and rotationally fixed manner in FIG. 1a and b. Furthermore, the current-conducting element comprises a second part 10, which is connected in a current-conducting manner to the inner ring 3 and is arranged so as to be rotatably movable relative to the inner ring 3 and the first part 9 of the current-conducting element.

The second part 10 of the current-conducting element 8 is arranged in the same axial plane as the first part 9 of the current-conducting element 8.

FIG. 1a shows the rolling bearing arrangement 1 in a schematic cross-section at 0°. FIG. 1b shows it in a schematic cross section as it could be configured, for example, at 90° in the direction of rotation. It is clear here that the second part 10 of the current-conducting element can thus be designed asymmetrically and can thus be elastically prestressed relative to the inner ring 3 and the first part of the current-conducting element 9. It is clear from FIG. 1 that the second part of the current-conducting element 10 can be designed in the form of a loop, for example in the form of a wire.

It is further clear from FIGS. 1a and 1b that the second part 10 of the current-conducting element 8 is guided by a geometric contour running over the circumference in the one of the inner rings 3 which is in direct electrical contact.

The second part 10 of the current-conducting element 8 can also be guided by a contour, for example by a contour that is concave in section and runs over the circumference. These two options can be implemented either separately or in combination.

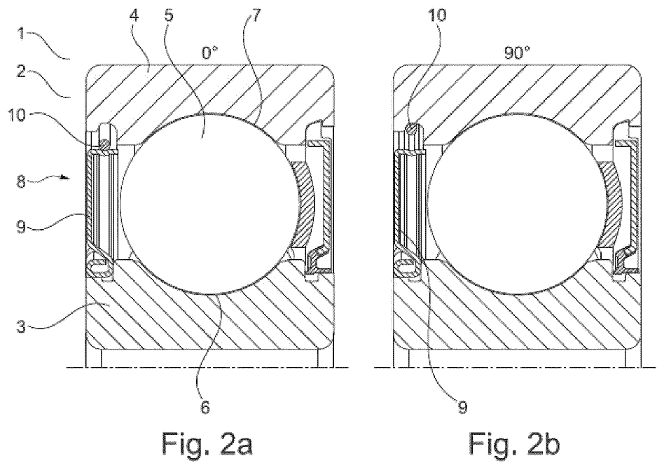

FIGS. 2a and b show a further embodiment in which the first part of the current-conducting element 8 is connected to the inner ring 3 in a current-conducting and rotationally fixed manner. The second part 10 of the current-conducting element is connected in a current-conducting manner to the outer ring 4 and is arranged so as to be rotatably movable relative to the outer ring 4 and the first part 9 of the current-conducting element.

As in FIGS. 1a and b, FIG. 2a also shows the rolling bearing arrangement 1 in a schematic cross-section at 0° and FIG. 1b shows the conceivable state in a schematic cross section at 90° in the direction of rotation.

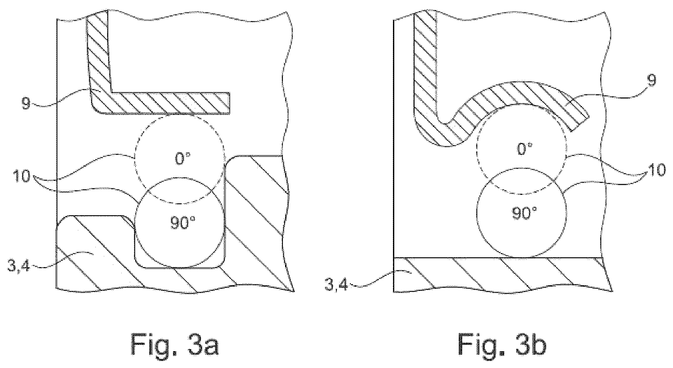

FIGS. 3a and b shows two guide options for the current-conducting element. In FIG. 3a, the second part 10 of the current-conducting element is guided by the bearing ring 3 or 4. As with FIGS. 1a and b and FIGS. 2a and b, FIGS. 3a and b show the conceivable position of the second part of the current-conducting element in a schematic cross-section at 0° and 90° in the direction of rotation.

Either a special contour can be provided or, in the case of existing bearing ring designs, the recess or seat of the seal can be used directly. In FIG. 3b, the second part 10 of the current-conducting element is guided by the first part of the current-conducting element 9. The contour intended for this purpose can be seen here.

For both guide options, the counter surface is shown as a cylindrical surface. However, it is also conceivable to combine the two guide options mentioned above. This would not lead to overdetermination even during bearing operation, since on the one hand the second part 10 of the current-conducting element has a certain elasticity and also does not have a fixed seat and is therefore rotatably movable relative to both contact partners.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SIGNS

1 Rolling bearing arrangement
2 Rolling bearing
3 Inner ring
4 Outer ring
5 Rolling body
6 Inner ring raceway
7 Outer ring raceway
8 Current-conducting element
9 First part of the current-conducting element
10 Second part of the current-conducting element

1. A rolling bearing arrangement comprising:
a rolling bearing having bearing rings and rolling bodies , wherein one of the bearing rings comprises an inner ring and another bearing ring comprises an outer ring, wherein the inner ring has an inner ring raceway and the outer ring has an outer ring raceway, wherein the rolling bodies are mounted in a rolling manner between the inner ring and the outer ring, and
a multi-part current-conducting element arranged between the inner ring and the outer ring and comprising a first part comprising a disc-like body and connected to the inner ring or to the outer ring in a current-conducting and rotationally fixed manner, wherein the multi-part current-conducting element comprises a second part connected to the other of the bearing rings in a current-conducting manner,
wherein the second part of the current-conducting element is rotatably movable relative to the bearing rings and the first part of the current-conducting element.

2. The rolling bearing arrangement according to claim 1, wherein the second part of the current-conducting element is arranged in the same axial plane as the first part of the current-conducting element.

3. The rolling bearing arrangement according to claim 1, wherein the second part of the current-conducting element is formed in a loop.

4. The rolling bearing arrangement according to claim 1, wherein the second part of the current-conducting element is guided by a geometric contour running over the circumference in the one of the bearing rings which is in direct electrical contact.

5. The rolling bearing arrangement according to claim 1, wherein the second part of the current-conducting element is guided by a concave contour running over the circumference in the first part of the current-conducting element.

6. The rolling bearing arrangement according to claim 1, wherein the second part of the current-conducting element contacts the first part of the current-conducting element and the part of bearing rings which is in direct electrical contact with it under prestress.

7. The rolling bearing arrangement according to claim 1, wherein the first part of the current-conducting element comprises a cover disc made of steel.

8. The rolling bearing arrangement according to claim 1, wherein the second part of the current-conducting element comprises carbon or carbon fibers.

9. The rolling bearing arrangement according to one claim 1, wherein the second part of the current-conducting element is formed by a flat or round wire made of spring steel.

10. A rolling bearing arrangement comprising:
a rolling bearing comprising bearing rings and rolling bodies, one of the bearing rings comprising an inner ring and another bearing ring comprises an outer ring, the inner ring comprising an inner ring raceway and the outer ring comprising an outer ring raceway, the rolling bodies mounted in a rolling manner between the inner ring and the outer ring; and
a multi-part current-conducting element positioned between the inner ring and the outer ring, the multi-part current-conducting element comprising a first part comprising a disc-like body and connected to the inner ring or the outer ring in a current-conducting and rotationally fixed manner, the multi-part current-conducting element comprising a second part connected to the other of the bearing rings in a current-conducting manner,
the second part of the current-conducting element rotatably movable relative to the bearing rings and the first part of the current-conducting element,
the second part of the current-conducting element arranged in the same axial plane as the first part of the current-conducting element.

11. The rolling bearing arrangement according to claim 10, wherein the second part of the current-conducting element is formed in a loop.

12. The rolling bearing arrangement according to claim 10, wherein the second part of the current-conducting element is guided by a geometric contour running over the circumference in the one of the bearing rings which is in direct electrical contact.

13. The rolling bearing arrangement according to claim 10, wherein the second part of the current-conducting element is guided by a concave contour running over the circumference in the first part of the current-conducting element.

14. The rolling bearing arrangement according to claim 10, wherein the second part of the current-conducting element contacts the first part of the current-conducting element and the part of bearing rings which is in direct electrical contact with it under prestress.

15. The rolling bearing arrangement according to claim 10, wherein the first part of the current-conducting element comprises a cover disc made of steel.

16. The rolling bearing arrangement according to claim 10, wherein the second part of the current-conducting element comprises carbon or carbon fibers.

17. The rolling bearing arrangement according to claim 10, wherein the second part of the current-conducting element is formed by a flat or round wire made of spring steel.

18. A drivetrain comprising:
a rolling bearing arrangement, wherein the rolling bearing arrangement comprises:
a rolling bearing comprising bearing rings and rolling bodies, one of the bearing rings comprising an inner ring and another bearing ring comprises an outer ring, the inner ring comprising an inner ring raceway and the outer ring comprising an outer ring raceway, the rolling bodies mounted in a rolling manner between the inner ring and the outer ring; and
a multi-part current-conducting element positioned between the inner ring and the outer ring, the multi-part current-conducting element comprising a first part comprising a disc-like body and connected to the inner ring or the outer ring in a current-conducting and rotationally fixed manner, the multi-part current-conducting element comprising a second part connected to the other of the bearing rings in a current-conducting manner,
the second part of the current-conducting element rotatably movable relative to the bearing rings and the first part of the current-conducting element.

19. The drivetrain according to claim 18, wherein the second part of the current-conducting element arranged in the same axial plane as the first part of the current-conducting element.

20. The drivetrain according to claim 18, wherein the second part of the current-conducting element is formed in a loop.
